(19) United States
(12) Patent Application Publication
(10) Pub. No.: US 2020/0162159 A1
(43) Pub. Date: May 21, 2020

(54) DIMMABLE DC-BIASED OPTICAL ORTHOGONAL FREQUENCY DIVISION MULTIPLEXING

(71) Applicant: Huawei Technologies Co., Ltd., Shenzhen (CN)

(72) Inventors: Dong Wei, Austin, TX (US); Beiyuan Liu, Hefei (CN); Nan Wu, Hefei (CN); Zhengyuan Xu, Hefei (CN)

(73) Assignee: Huawei Technologies Co., Ltd., Shenzhen (CN)

(21) Appl. No.: 16/619,291

(22) PCT Filed: Jun. 1, 2018
(86) PCT No.: PCT/US2018/035666

§ 371 Date: Dec. 4, 2019

Related U.S. Application Data
(60) Provisional application No. 62/515,292, filed on Jun. 5, 2017.

(51) Int. Cl. H04B 10/116; H04B 10/50; H04B 10/516

(52) U.S. Cl. CPC H04B 10/116; H04B 10/516; H04B 10/502

(57) ABSTRACT

A computer implemented method, system, and device for direct-current biased optical frequency-division multiplexing (DCO-OFDM) modulation includes generating a DCO-OFDM signal with odd-indexed subcarriers carrying data, suppressing even-indexed subcarriers of the DCO-OFDM signal, and transmitting the DCO-OFDM signal via a light source.

### CROSS-REFERENCE TO RELATED APPLICATION

This application claims priority to U.S. Provisional Application Ser. No. 62/515,292 (AN OPTICAL ORTHOGONAL FREQUENCY-DIVISION MULTIPLEXING METHOD IMMUNE TO NON-LINEARITY OF LED, filed Jun. 5, 2017) which is incorporated herein by reference.

### TECHNICAL FIELD

The present disclosure is related to optical orthogonal frequency division multiplexing communications, and in particular, to dimmable direct current biased optical orthogonal frequency division multiplexing for visible light communication.

### BACKGROUND

Visible light communication (VLC) is a data communications variant which uses visible light for communication. VLC is a subset of optical wireless communications technologies.

Recent advancements in solid-state lighting have enabled Light Emitting Diodes (LEDs) to switch to different light intensity levels at a rate which is fast enough to be imperceptible by a human eye. This functionality can be used for visible light communication (VLC) where the data is encoded in the emitting light in various ways. A photodetector (also referred as a light sensor or a photodiode) or an image sensor (a matrix of photodiodes) can receive the modulated signals and decode the data.

### SUMMARY

Various examples are now described to introduce a selection of concepts in a simplified form that are further described below in the detailed description. The Summary is not intended to identify key or essential features of the claimed subject matter, nor is it intended to be used to limit the scope of the claimed subject matter.

According to one aspect of the present disclosure, a computer implemented method for direct-current biased optical frequency-division multiplexing (DCO-OFDM) modulation includes generating a DCO-OFDM signal with odd-indexed subcarriers carrying data, suppressing even-indexed subcarriers of the DCO-OFDM signal, and transmitting the DCO-OFDM signal via a light source.

Optionally, in any of the preceding aspects, a further implementation of the aspect includes performing an inverse fast Fourier transform to convert the DCO-OFDM signal to a time domain signal.

Optionally, in any of the preceding aspects, a further implementation of the aspect includes adding a DC bias to the time domain signal, clipping the time domain signal with DC bias current, and converting the clipped signal to a DCO-OFDM current for driving a light source.

Optionally, in any of the preceding aspects, a further implementation of the aspect includes adding a cyclic prefix to the time domain signal with DC bias prior to clipping. Optionally, in any of the preceding aspects, a further implementation of the aspect includes suppressing even-indexed subcarriers by inserting zeros for such subcarriers, and further comprising imposing Hermitian symmetry on the DCO-OFDM signal prior to suppressing the even-indexed subcarriers.

Optionally, in any of the preceding aspects, a further implementation of the aspect includes receiving a sequence of QAM symbols. Optionally, in any of the preceding aspects, a further implementation of the aspect includes wherein suppressing even-indexed subcarriers makes the drive current immune to the quadratic distortion resulting from the light source.

Optionally, in any of the preceding aspects, a further implementation of the aspect includes wherein Hermitian symmetry is imposed on the DCO-OFDM signal. Optionally, in any of the preceding aspects, a further implementation of the aspect includes wherein the light source comprises a light emitting diode (LED).

According to one aspect of the present disclosure an optical communications device includes a memory storage comprising instructions and one or more processors in communication with the memory storage. The one or more processors execute the instructions to perform operations for direct-current biased optical frequency-division multiplexing (DCO-OFDM) modulation. The operations include generating a DCO-OFDM signal with odd-indexed subcarriers carrying data, suppressing even-indexed subcarriers of the DCO-OFDM signal, and transmitting the DCO-OFDM signal via a light source.

Optionally, in any of the preceding aspects, a further implementation of the aspect includes performing an inverse fast Fourier transform to convert the symmetric sequence of DCO-OFDM symbols to a time domain signal, adding a DC bias to the time domain signal, adding a cyclic prefix to the time domain signal with DC bias, clipping the time domain signal with DC bias current, and converting the clipped signal to a DCO-OFDM current for driving a light source.

Optionally, in any of the preceding aspects, a further implementation of the aspect includes receiving a sequence of QAM symbols, and wherein suppressing even-indexed subcarriers makes the drive current immune to the quadratic distortion resulting from the light source.

Optionally, in any of the preceding aspects, a further implementation of the aspect includes a light emitting diode (LED). The operations further comprise driving the LED with the DCO-OFDM signal to transmit data to a photo receptor.

According to one aspect of the present disclosure, a computer-readable media stores computer instructions for direct-current biased optical frequency-division multiplexing (DCO-OFDM) modulation that, when executed by one or more processors, cause the one or more processors to perform the steps of generating a DCO-OFDM signal with odd-indexed subcarriers carrying data, suppressing even-indexed subcarriers of the DCO-OFDM signal, and controlling a light source and transmitting the DCO-OFDM signal via a light source.

Optionally, in any of the preceding aspects, a further implementation of the aspect includes receiving a sequence of QAM symbols and wherein suppressing even-indexed subcarriers makes the drive current immune to the quadratic distortion resulting from the light source.

### BRIEF DESCRIPTION OF THE DRAWINGS

FIG. 1 is a block diagram representation of a VLC system that utilizes light for both illumination and communication according to an example embodiment.

FIG. 2 is a block flow diagram illustrating a physical-layer implementation of a VLC system based on DCO-OFDM (direct current biased optical orthogonal frequency division multiplexing) modulation according to an example embodiment.

FIG. 3 is a graph illustrating example curves of emitted optical power as a bit error rate (BER) for a set of constellations according to an example embodiment.

FIG. 4 is a graph illustrating example curves of emitted optical power as a bit error rate (BER) for a different set of constellations according to an example embodiment.

FIG. 5 is a flowchart illustrating a computer implemented method of operation of a DCO-OFDM based VLC system according to an example embodiment.

FIG. 6 is a block diagram of an example data processing system in which aspects of the illustrative embodiments may be implemented.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC (application specific integrated circuit), microprocessor, or other type of processor operating on a computer system, such as a personal computer, server or other computer system, turning such computer system into a specifically programmed machine.

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Light transmission sources, such as light-emitting diodes (LEDs) are used as optical-wireless transmitters in VLC systems. In a VLC system, information is transmitted via the instantaneous optical power of the LED, which is driven by an instantaneous current. Dual functional VLC systems can simultaneously provide illumination and communication capabilities using a dimming functionality. Optical orthogonal frequency division multiplexing (OFDM) is a suitable modulation scheme for VLC to achieve higher data rates. In particular, in direct-current (DC) biased optical OFDM (DCO-OFDM), the bipolar OFDM signal is converted to a unipolar signal by adding a DC bias and is used as electric current to drive the LED.

The linear dynamic range of the LED radiation power is quite limited, which impacts the data rate and dimming capability of DCO-OFDM. If the DC bias is adjusted within a large dynamic range (i.e. using both high and low DC bias), the LED radiation power (representing the optical signal) will be out of its linear dynamic range and hence suffer severe nonlinear distortion, which will result in performance degradation in communication applications. If the DC bias is limited to within a small dynamic range (i.e. using low DC bias), both the data rate and the dimming capability are significantly limited.

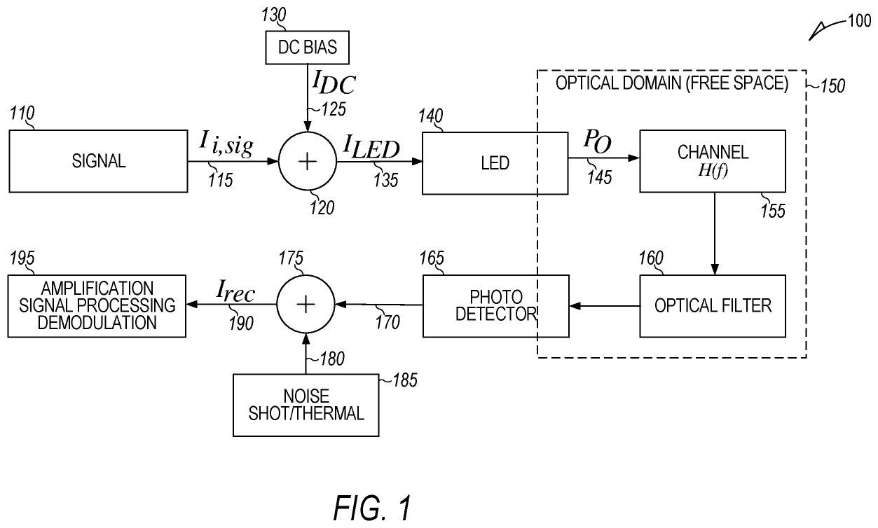

FIG. 1 is a block diagram representation of a VLC system 100 that utilizes light for both illumination and communication. A signal module 110 having encoded data to be communicated is converted to a current I_{t,sig} on connector 115 and provided to a summing junction 120 along with a DC bias current on connection 125 shown as signal I_{DC} 130. The summing junction 120 adds the two signals to provide a current I_{LED} on connection 135 to a light emitting diode (LED) 140. The DC bias current 130 is provided to ensure that the drive current signal is substantially nonnegative. The LED 140 emits light and provides the light in channel H(f) 155, with a power P_{O} at 145, to an optical domain 150. The emitted light is propagated through the optical domain 150. The optical domain 150 can comprise free air, or alternatively can comprise any manner of suitable transmission medium, including an optical fiber, for example. An optical filter 160, also in the optical domain 150, receives the optical power P_{O} and passes light to a photo detector 165 for detecting the light intensity. In one embodiment, the optical filter may be a band-pass optical filter for passing light in a band that photo detector 165 can most effectively and reliably receive and process to detect the intensity of the light caused by I_{t,sig}.

In some embodiments, the brightness of the LED 140 is adjusted by controlling the forward current through the LED 140. In practice, a challenge of VLC is to ensure dimming functionality while maintaining a reliable communication link. If the LED 140 is dimmed too much, the dimming can make signal transmission/reception difficult and unreliable. The photo detector 165 provides a signal on connector 170 to a further summing junction 175 that also receives a thermally adjusted noise shot on connector 180 from a noise source 185. The summed signals from the photo detector 165 and noise source 185, I_{rec} (received current) is provided via connector 190 to a signal processing module 195 for amplification, signal processing, and demodulation to obtain the encoded transmitted data.

In one embodiment, the optical power generated by the LED 140 is modelled as a quadratic function of the DCO-OFDM current signal as described in further detail below. Second-order distortion, also referred to as quadratic distortion (in the form of inter-subcarrier interference) is caused by the sum of the product of the data carried on each pair of different subcarriers. If both subcarrier indices are odd or even, the distortion falls onto even-indexed subcarriers. If two subcarrier indices have different parity, the distortion falls onto odd-indexed subcarriers.

The quadratic distortion by the LED 140 is avoided in one embodiment, by setting the in-phase and quadrature components on all even subcarriers to zeros and using the odd-indexed subcarriers to carry data in signal module 110, resulting in Odd-DCO-OFDM.

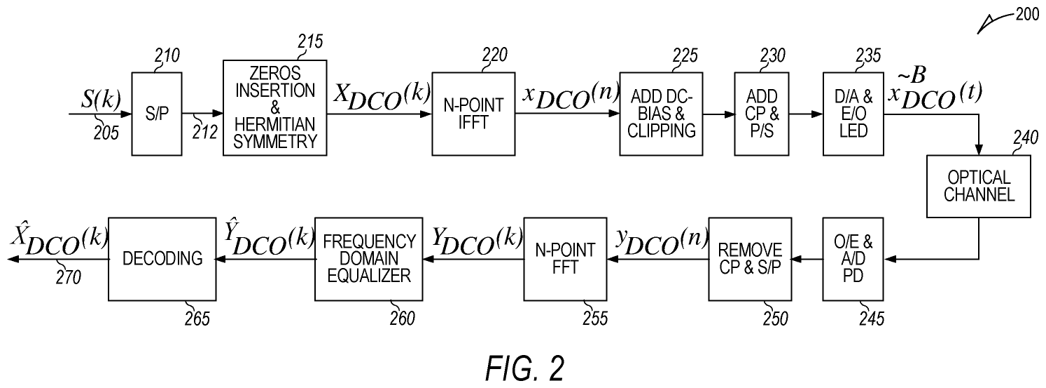

FIG. 2 is a block flow diagram illustrating a physical-layer implementation of a VLC system 200 based on DCO-OFDM in accordance with an embodiment. Usually, the linear dynamic range of the LED radiation power is quite limited. If the DC bias is adjusted within a large dynamic range, the LED radiation power (representing the optical signal) will be out of its linear dynamic range and hence suffer severe nonlinear distortion, which will result in performance degradation in communication. If the DC bias is limited within a small dynamic range, the VLC system will have a limited dimming capability.

A serial signal S(k) at 205 represents or encodes data to be transmitted. In one embodiment, S(k) is a quadrature amplitude modulation (QAM) symbol usually represented as a complex number: S(k)=I(k)+jQ(k), where I and Q are the in-phase and quadrature components, respectively. The data is converted from serial form to parallel form at serial to parallel converter 210. The parallel form of the signal is an input vector that is provided via connector 212 to a first processing block 215.

First processing block 215 processes the input vector to insert zeros on even-indexed subcarriers and impose symmetry. For a given sequence of QAM symbols,

$$[ S ( 1 ) , S ( 2 ) , … , S ( \frac{N}{4} ) ] ,$$

where N is a multiple of 4, the first N/2+1 components of X_{DCO} are formed as follows:

$${X}_{DCO} ( k ) = \{ \begin{matrix}S ( \frac{k + 1}{2} ) , & k = 1 , 3 , 5 , … , \frac{N}{2} - 1 \\ 0 , & k = 0 , 2 , 4 , … , \frac{N}{2}\end{matrix} \qquad ( 1 )$$

In one embodiment, Hermitian symmetry is imposed on the parallel form of the signal X_{DCO}(k) to define the last N/2−1components of X_{DCO}. This is done to ensure the IDFT (inverse discrete Fourier transform) outputs are real valued time-domain samples:

$${X}_{DCO} ( k ) = {{X}_{DCO} ( N - k )}^{*} for k = \frac{N}{2} + 1 , \frac{N}{2} + 2 , … , N - 1 \qquad ( 2 )$$

where * denotes complex conjugation. The new length-N vector [X_{DCO}(0), X_{DCO}(1), . . . , X_{DCO}(N−1)] contains all the information of the aforementioned data sequence. The new vector includes even and odd-indexed subcarriers. X_{DCO}(0), X_{DCO}(2), X_{DCO}(4), . . . , and X_{DCO}(N−2) are the QAM symbols on the even-indexed subcarriers, and X_{DCO}(1), X_{DCO}(3), X_{DCO}(5), . . . , and X_{DCO}(N−1) are the QAM symbols on the odd-indexed subcarriers. Even-indexed subcarriers are suppressed by setting X_{DCO}(0)=X_{DCO}(2)=X_{DCO}(4)= . . . =X_{DCO}(N−2)=0. As a result, zeros are inserted on even-indexed terms of X_{DCO}(k) and the odd-indexed subcarriers are used for carrying data.

First processing block 215 thus ensures that the resulting DCO-OFDM signal is immune to quadratic distortion caused by the LED. For the same number of loaded bits per sub-carrier, the use of odd carriers for data and zeroing even carriers may significantly improve dimming range control over conventional DCO-OFDM.

VLC system 200 proceeds in a conventional manner to perform N-point IFFT (inverse fast Fourier transform) at processing block 220. As indicated above, Hermitian symmetry imposed on the input vector to processing block 220 ensures the IDFT outputs are real valued time-domain samples. A DC bias is digitally added, and clipping is performed in processing block 225 (i.e. setting negative time-domain samples to zero). Digital cyclic prefixes (CP) are added and a conversion back to serial form (parallel to serial (P/S)) is performed at processing block 230. A digital to analog (D/A) conversion and an electrical to optical (E/O) conversion and transmission are performed via LED block 235.

The resulting optical signal may be transmitted over an optical channel 240 and received by a photo diode or photo detector (PD) at processing block 245. Processing block 245 converts the received optical signal from optical to electrical (O/E) and from analog to digital (A/D). At processing block 250, the cyclic prefixes are removed and conversion from serial to parallel (S/P) is performed. The signal is converted to a frequency domain signal via N-Point FFT at 255, frequency domain equalized at 260, and decoded at 265 to provide an electrical output signal on connector 270.

In one embodiment, the instantaneous optical power of the LED 235, P (t), can be modeled by a quadratic polynomial function of the instantaneous driving current, I(t), as:

P(t)=b₁I(t)+b₂I(t)² (3)

where coefficients b₁ and b₂ are the linear coefficient and the second-order nonlinearity coefficient, respectively, and I is the current applied to the LED. The LED transfer function is thus a quadratic function that may be a source of quadratic distortion. The DCO-OFDM current signal is modified as described above to suppress such quadratic distortion.

In one embodiment, a DCO-OFDM current signal provided to LED 235 can be represented as:

I(t)=Σₙ₌₀^{N-1}[Iₙ cos(2πfₙt)−Qₙ sin(2πfₙt)]+I_{DC} (4)

where N is the number of subcarriers and is even, t is time, fₙ are the subcarrier frequencies, and I_{DC} is the DC bias. Due to the Hermitian symmetry of OFDM and the fact that the 0th and N/2-th subcarriers do not carry information, the OFDM current signal can be rewritten as:

$$I ( t ) = {\sum }_{n = 1}^{\frac{N}{2} - 1} [ 2 {I}_{n} cos ( 2 π {f}_{n} t ) - 2 {Q}_{n} sin ( 2 π {f}_{n} t ) ] + {I}_{D C} \qquad ( 5 )$$

where Iₙ and Qₙ are the in-phase and quadrature components on the nth subcarrier, respectively. The optical power of the LED can be expressed as

$$P ( t ) = {b}_{1} {I}_{D C} + {b}_{2} {I}_{D C}^{2} + 2 {b}_{2} {\sum }_{n = 1}^{\frac{N}{2} - 1} ( {I}_{n}^{2} + {Q}_{n}^{2} ) + ( {b}_{1} + 2 {b}_{2} {I}_{D C} ) {\sum }_{n = 1}^{\frac{N}{2} - 1} [ 2 {I}_{n} cos ( 2 π {f}_{n} t ) - 2 {Q}_{n} sin ( 2 π {f}_{n} t ) ] + 4 {b}_{2} {\sum }_{n = 1}^{\frac{N}{2} - 1} {\sum }_{m = n + 1}^{\frac{N}{2} - 1} \{ ( {I}_{n} {I}_{m} - {Q}_{n} {Q}_{m} ) cos [ 2 π ( {f}_{n} + {f}_{m} ) t ] - ( {I}_{n} {Q}_{m} + {I}_{m} {Q}_{n} ) sin [ 2 π ( {f}_{n} + {f}_{m} ) t ] + ( {I}_{n} {I}_{m} + {Q}_{n} {Q}_{m} ) cos [ 2 π ( {f}_{m} - {f}_{n} ) t ] + ( {I}_{m} {Q}_{n} - {I}_{n} {Q}_{m} ) sin [ 2 π ( {f}_{m} - {f}_{n} ) t ] \} + 2 {b}_{2} {\sum }_{n = 1}^{\frac{N}{2} - 1} ( {I}_{n}^{2} - {Q}_{n}^{2} ) cos ( 2 π \cdot 2 {f}_{n} t ) \qquad ( 6 )$$

On the subcarrier with frequency fₛ, the in-phase and quadrature components of the optical power of the LED can be expressed as:

$$I component \text{:} ( {b}_{1} + 2 {b}_{2} {I}_{D C} ) {I}_{s} + 2 {b}_{2} {\sum }_{i + j = s} ( {I}_{i} {I}_{j} - {Q}_{i} {Q}_{j} ) + 2 {b}_{2} {\sum }_{i + j = N - s} ( {I}_{i} {I}_{j} - {Q}_{i} {Q}_{j} ) + 2 {b}_{2} {\sum }_{i - j = s} ( {I}_{i} {I}_{j} + {Q}_{i} {Q}_{j} ) + 2 {b}_{2} {\sum }_{i - j = s} ( {I}_{i} {I}_{j} + {Q}_{i} {Q}_{j} ) + {b}_{2} ( {I}_{\frac{s}{2}}^{2} - {Q}_{\frac{s}{2 }}^{2} ) + {b}_{2} ( {I}_{\frac{N - s}{2}}^{2} - {Q}_{\frac{N - s}{2}}^{2} ) \\ Q component \text{:} ( {b}_{1} + 2 {b}_{2} {I}_{D C} ) {Q}_{s} + 2 {b}_{2} {\sum }_{i + j = s} ( {I}_{i} {Q}_{j} + {I}_{j} {Q}_{i} ) + 2 {b}_{2} {\sum }_{i + j = N - s} ( {I}_{i} {Q}_{j} + {I}_{j} {Q}_{i} ) + 2 {b}_{2} {\sum }_{i - j = s} ( {I}_{i} {Q}_{j} - {I}_{j} {Q}_{i} ) \qquad ( 7 )$$

where I_{s/2}² and Q_{s/2}² are zero if s is odd.

From the above expressions, the disclosed embodiments recognize that if both i and j are odd or even, the non-linear distortion in the form of inter-carrier interference in the optical power will fall onto the even-indexed subcarriers. Otherwise, the interference is the linear combination of IᵢIⱼ and QᵢQⱼ, and will fall onto the odd-index subcarriers. Therefore, in one embodiment, the nonlinear distortion may be avoided by setting the in-phase and quadrature components of the DCO-OFDM current signal on the even-indexed subcarriers to zeros at first processing block 215. That is, only the odd-indexed subcarriers of DCO-OFDM are used to carry information. Thus, in one embodiment, this type of DCO-OFDM is referred to as “Odd-DCO-OFDM”.

In one embodiment, the dimming capabilities of DCO-OFDM and Odd-DCO-OFDM are numerically compared. Taken by the inverse Fast

Fourier transform (FFT), the bipolar OFDM signals are added by different DC currents from 0.1 to 1.4, which are the normalized values that may be used for numerical simulation. In one embodiment, the limit line of forward error correction (FEC) is set to 10⁻³.

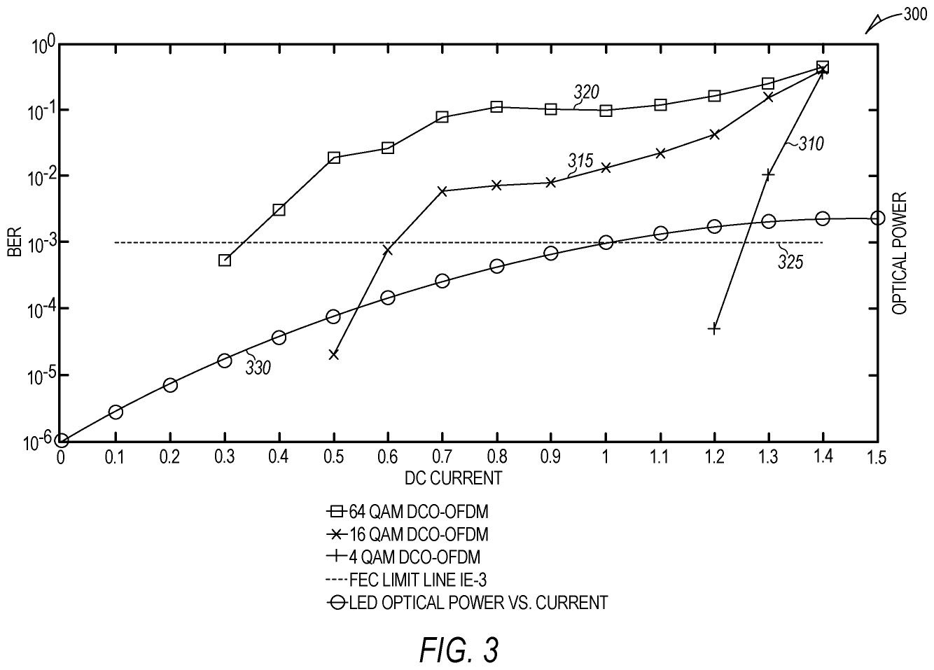

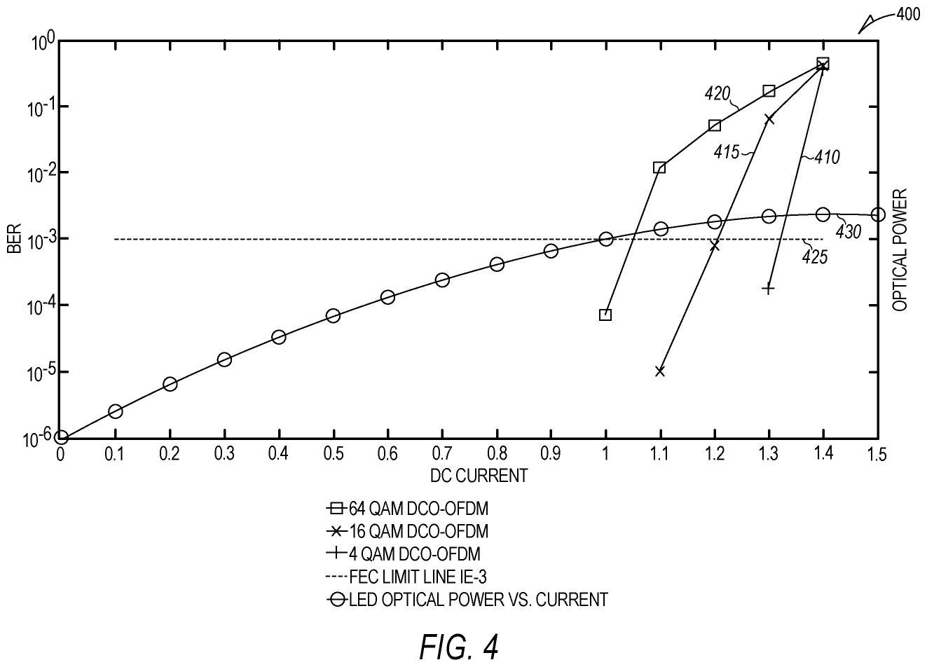

Example curves of emitted optical power are plotted in FIG. 3 at 300 and FIG. 4 at 400 in accordance with an embodiment, as bit error rate (BER) versus DC bias current. In the depicted embodiment, a 128-point FFT is used. A total of 63 subcarriers are available in DCO-OFDM and 32 in Odd-DCO-OFDM. OFDM symbols are drawn from 4-QAM represented by line 310, 410, 16-QAM represented by line 315, 415, and 64-QAM represented y line 320, 420. Optical power is shown as line 330, 430 and an FEC Limit Line IE-3 is shown at 325, 425. In one embodiment, the received optical signals at the receiver are interfered by additive white Gaussian noise. In the depicted embodiment, all the results are simulated under the condition of 10 dB SNR.

Due to the nonlinear characteristic, the distortion becomes more severe as the DC current increases. Because the average optical power is dominated by the DC component, the dimming range can be defined for different constellations. In FIG. 3, the available dimming range for 4-QAM is from 0.1 to 1.2, the available dimming range for 16-QAM shrinks to [0.1, 0.6], and the range for 64-QAM narrows to [0.1, 0.3]. In one embodiment, the optical power is more difficult to adjust when a larger constellation used.

The bit-error rate (BER) performance of Odd-DCO-OFDM with different constellations is shown in FIG. 4 in accordance with an embodiment. In the depicted embodiment, the available dimming ranges are [0.1, 1.3], [0.1, 1.2], and [0.1, 1.0] for 4-QAM, 16-QAM, and 64-QAM, respectively. Usually, the dimming range is defined from [0.1, 1.0]. Thus, in accordance with an embodiment; Odd-DCO-OFDM is able to realize the dimming control within the full range for any constellation. But DCO-OFDM fails when 16-QAM and 64-QAM are used. Thus, the disclosed embodiments of Odd-DCO-OFDM are more effective than DCO-OFDM for dimming control.

The disclosed DCO-OFDM embodiments are less affected by the non-linearity of the LED and hence lead to a significantly larger dynamic range for the DC bias. As a result, the disclosed embodiments enable a DCO-OFDM-based VLC system to support a broad range of dimming while maintaining reliable communication.

The disclosed embodiments may be a system, an apparatus, a method, and/or a computer program product at any possible technical detail level of integration. The computer program product may include a computer readable storage medium (or media) having computer readable program instructions thereon for causing a processor to carry out aspects of the present disclosure.

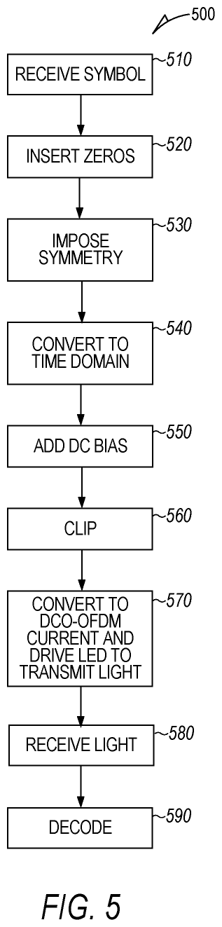

FIG. 5 is a flowchart illustrating a computer implemented method 500 of operation of a DCO-OFDM based VLC system according to an example embodiment. In one embodiment, the VLC system may be implemented on an ASIC chip with an integrated LED. At operation 510, a sequence of quadrature amplitude modulation (QAM) symbols having encoded data to be transmitted is received. The received sequence is processed via operation 520 to impose symmetry. The symmetry imposed may be Hermitian symmetry in one embodiment. A zero is inserted between each pair of consecutive QAM symbols at operation 530. Operation 530 may scan through each subcarrier and determine whether or not the subcarrier index is odd or even. Zeroes are then inserted on the even-indexed subcarriers. In one embodiment, the zeroes are inserted on even-indexed subcarriers at operation 530 such that only the odd-indexed subcarriers of the input to the IDFT carry data.

At operation 540, an inverse fast Fourier transform may be performed to convert the symmetric sequence of QAM symbols to a time domain signal. In one embodiment, method 500 includes adding a DC bias to the time domain signal at operation 550 and clipping the time domain signal with DC bias at operation 560. A cyclic prefix is added to the time domain signal with DC bias at operation 550 prior to clipping. The clipped signal is converted to a DCO-OFDM (direct current biased optical orthogonal frequency division multiplexing) current for driving a light source at operation 570.

At operation 570, a light source, such as a light emitting diode (LED) may be driven with the DCO-OFDM signal to transmit data to a photo receptor. The suppression of even-indexed subcarriers ensures that light emitted from the LED is essentially free of quadratic distortion. The light from the LED may be received by a photo-detector at operation 580 and decoded at operation 590.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, or any suitable combination of the foregoing. A computer readable storage medium, as used herein, is not to be construed as being transitory signals to the extent such signals are deemed too transitory.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block flow diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented method, such that the instructions which execute on the computer, other programmable apparatus, or other device implement the functions/acts specified in the flowchart and/or block diagram block or blocks.

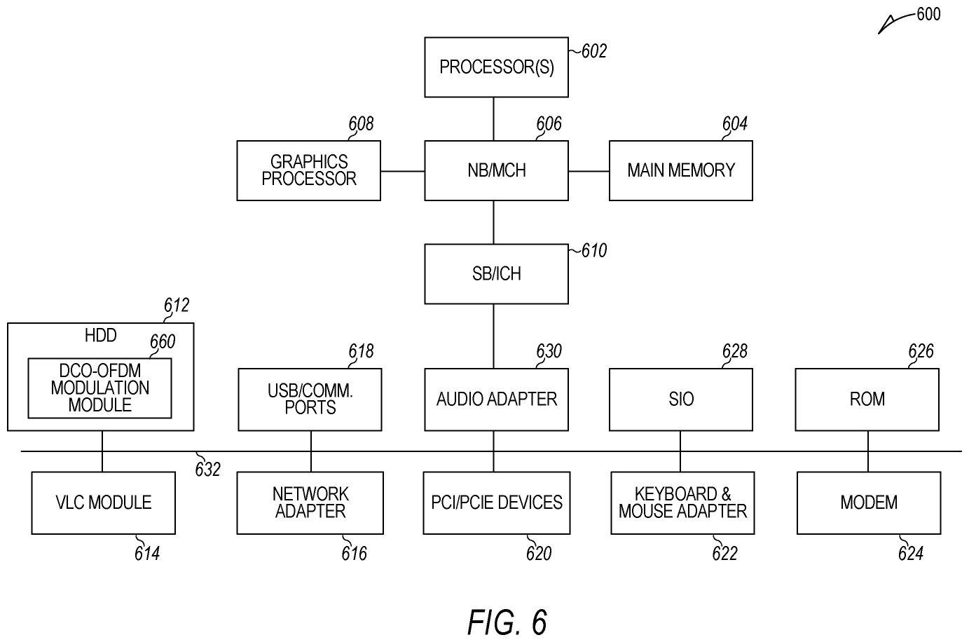

FIG. 6 is a block diagram of an example data processing system in which aspects of the illustrative embodiments may be implemented. In the depicted example, data processing system 600 employs a hub architecture including north bridge and memory controller hub (NB/MCH) 606 and south bridge and input/output (I/O) controller hub (SB/ICH) 610. Processor(s) 602, main memory 604, and graphics processor 608 are connected to NB/MCH 606. Graphics processor 608 may be connected to NB/MCH 606 through an accelerated graphics port (AGP). A computer bus 632 may be implemented using any type of communication fabric or architecture that provides for a transfer of data between different components or devices attached to the fabric or architecture. The term “computer implemented” includes implementation on an ASIC with integrated LED.

In the depicted example, a network adapter 616 connects to SB/ICH 610. Audio adapter 630, keyboard and mouse adapter 622, modem 624, read only memory (ROM) 626, hard disk drive (HDD) 612, a VLC module 614, universal serial bus (USB) ports and other communication ports 618, and Peripheral Component Interconnect/Peripheral Component Interconnect Express (PCI/PCIe) devices 620 connect to SB/ICH 610 through computer bus 632. PCI/PCIe devices 620 may include, for example, Ethernet adapters, add-in cards, and PC cards for notebook computers. PCI uses a card bus controller, while PCIe does not. ROM 626 may be, for example, a flash basic input/output system (BIOS). Modem 624 or network adapter 616 may be used to transmit and receive data over a network.

HDD 612 and VLC module 614 connect to SB/ICH 610 through computer bus 632. HDD 612 may use, for example, an integrated drive electronics (IDE) or serial advanced technology attachment (SATA) interface. Super I/O (SIO) device 628 may be connected to SB/ICH 610. In some embodiments, HDD 612 may be replaced by other forms of data storage devices including, but not limited to, solid-state drives (SSDs).

An operating system runs on processor(s) 602. The operating system coordinates and provides control of various components within the data processing system 600 in FIG. 4. Non-limiting examples of operating systems include the Advanced Interactive Executive (AIX®) operating system, Microsoft Windows® operating system, and the LINUX® operating system. Various applications and services may run in conjunction with the operating system.

Data processing system 600 may include a single processor 602 or may include a plurality of processors 602. Additionally, processor(s) 602 may have multiple cores. For example, in one embodiment, data processing system 600 may employ a large number of processors 602 that include hundreds or thousands of processor cores. In some embodiments, the processors 602 may be configured to perform a set of coordinated computations in parallel.

Instructions for the operating system, applications, and other data are located on storage devices, such as one or more HDDs 612, and may be loaded into main memory 604 for execution by processor(s) 602. For instance, in one embodiment, the HDD 612 may include instructions for carrying out the various embodiments described herein. For example, in one embodiment, the HDD 612 comprises a DCO-OFDM modulation module 660 comprising instructions and other data that, when executed by the processor 602, performs the processes described herein. Alternatively, the instructions and/or the DCO-OFDM modulation module 660 can be stored in the main memory 604.

In one embodiment, the DCO-OFDM modulation module 660 provides instructions for the VLC module 614. In one embodiment, the VLC module 614 may include a signal conditioner, a signal modulator, a signal driver, and one or more LEDs. In one embodiment, the signal modulator utilizes On-Off Keying (OOK) for turning the LEDs off and on according to the bits in the signal stream. In one embodiment, the LED is not turned completely off in the off state, but the level of intensity is reduced. The signal driver provides a driving current. In an alternative embodiment, the VLC module 614 may be an external component, module, or system that is communicatively coupled to the data processing system 600. A similar VLC receiver is also proposed herein.

In some embodiments, additional instructions or data may be stored on one or more external devices. The processes for illustrative embodiments of the present disclosure may be performed by processor(s) 602 using computer usable program code, which may be located in a memory such as, for example, main memory 604, ROM 626, HDD 612, or in one or more peripheral devices.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

The computer-readable program instructions, also referred to as computer-readable non-transitory media, includes all types of computer readable media, including magnetic storage media, optical storage media, flash media and solid-state storage media.

It should be understood that software can be installed in and sold with the data processing system. Alternatively, the software can be obtained and loaded into the data processing system, including obtaining the software through physical medium or distribution system, including, for example, from a server owned by the software creator or from a server not owned but used by the software creator. The software can be stored on a server for distribution over the Internet, for example.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the scope disclosed herein. Therefore, the specification and drawings are to be regarded simply as an illustration of the disclosure as defined by the appended claims, and are contemplated to cover any and all modifications, variations, combinations or equivalents that fall within the scope of the present disclosure.

In one example, a computer implemented method, system, and device for direct-current biased optical frequency-division multiplexing (DCO-OFDM) modulation includes generating a DCO-OFDM signal with odd-indexed subcarriers carrying data, suppressing even-indexed subcarriers of the DCO-OFDM signal, and transmitting the DCO-OFDM signal via a light source.

In a further example, a system, a method, and an apparatus provide for direct-current biased optical frequency-division duplexing (DCO-OFDM) modulation as disclosed herein.

In yet a further example, a method performs optical orthogonal frequency-division multiplexing (OFDM) for an LED wherein the optical OFDM method is substantially immune to a non-linearity of the LED, as disclosed herein.

A method of operating a LED in a direct current optical (DCO) orthogonal frequency-division multiplexing (OFDM) communication system, the method includes generating a DCO-OFDM current signal I(t) according to I(t)=Σₙ₌₀^{N-1}[Iₙ cos(2πfₙt)−Qₙ sin(2πfₙt)]+I_{DC}, setting the in-phase and quadrature components on even-indexed subcarriers to zeros to generate a modified current signal I′ (t), wherein the modified current signal I′ (t) features a greatly reduced sensitivity to non-linearity of light generated by the LED.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method for direct-current biased optical frequency-division multiplexing (DCO-OFDM) modulation, the method comprising:
generating a DCO-OFDM signal with odd-indexed subcarriers carrying data;
suppressing even-indexed subcarriers of the DCO-OFDM signal; and
transmitting the DCO-OFDM signal via a light source.

2. The method of claim 1, further comprising performing an inverse fast Fourier transform on the DC-OFDM signal to convert the DCO-OFDM signal to a time domain signal.

3. The method of claim 1, further comprising:
adding a DC bias to the time domain signal to generate a biased time domain signal;
clipping the biased time domain signal to generate a clipped biased time domain signal; and
converting the clipped biased time domain signal to a DCO-OFDM current for driving the light source.

4. The method of claim 3, further comprising adding a cyclic prefix to the biased time domain signal prior to the clipping.

5.-8. (canceled)

9. The method of any of claim 1, wherein the light source comprises a light emitting diode (LED).

10. An optical communications device, comprising:
a memory storage comprising instructions; and
one or more processors in communication with the memory storage, the one or more processors executing the instructions to perform direct-current biased optical frequency-division multiplexing (DCO-OFDM) modulation, the one or more processors executing the instructions to:
generate a DCO-OFDM signal with odd-indexed subcarriers carrying data;
suppress even-indexed subcarriers of the DCO-OFDM signal; and
transmit the DCO-OFDM signal via a light source.

11. The optical communications device of claim 10,
the one or more processors further executing the instructions to perform an inverse fast Fourier transform on the DCO-OFDM signal to convert the DCO-OFDM signal to a time domain signal.

12. (canceled)

13. The optical communications device of claim 10 further comprising a light emitting diode (LED), the one or more processors further executing the instructions to drive the LED with the DCO-OFDM signal to transmit the data.

14. A computer-readable media storing computer instructions for direct-current biased optical frequency-division multiplexing (DCO-OFDM) modulation, that when executed by one or more processors, cause the one or more processors to:
generate a DCO-OFDM signal with odd-indexed subcarriers carrying data;
suppress even-indexed subcarriers of the DCO-OFDM signal; and
control a light source and transmitting the DCO-OFDM signal via the light source.

15. (canceled)

16. The method of claim 1, further comprising receiving a sequence of QAM symbols and generating the DCO-OFDM signal based on the sequence of QAM symbols.

17. The method of claim 1, wherein the suppressing the even-indexed subcarriers comprises inserting zeros for the even-indexed subcarriers.

18. The method of claim 1, wherein the suppressing the even-indexed subcarriers makes a drive current immune to a quadratic distortion resulting from the light source.

19. The method of claim 1, further comprising imposing Hermitian symmetry on the DCO-OFDM signal prior to the suppressing the even-indexed subcarriers.

20. The optical communications device of claim 10, the one or more processors further executing the instructions to receive a sequence of QAM symbols and generate the DC-OFDM signal based on the sequence of QAM symbols.

21. The optical communications device of claim 10, wherein the suppressing the even-indexed subcarriers comprises inserting zeros for the even-indexed subcarriers.

22. The optical communications device of claim 10, wherein the suppressing the even-indexed subcarriers makes a drive current immune to a quadratic distortion resulting from the light source.

23. The optical communications device of claim 10, further comprising imposing Hermitian symmetry on the DCO-OFDM signal prior to the suppressing the even-indexed subcarriers.

24. The optical communications device of claim 10, the one or more processors further executing the instructions to:
add a DC bias to the time domain signal to generate a biased time domain signal;
clip the biased time domain signal to generate a clipped biased time domain signal; and
convert the clipped biased time domain signal to a DCO-OFDM current for driving the light source.

25. The optical communications device of claim 24, further comprising adding a cyclic prefix to the biased time domain signal prior to the clipping.
